(19) United States
(12) Patent Application Publication
(10) Pub. No.: US 2003/0012441 A1
(43) Pub. Date: Jan. 16, 2003

(54) Detection of lines in images

(75) Inventors: Mikhail Ivanovich Trifonov, Sosnovyi Bor (RU); Olga Vadimovna Sharonova, Saint Petersburg (RU); Krzysztof Antoni Zaklika, Saint Paul, MN (US)

Correspondence Address: MARK A. LITMAN & ASSOCIATES, P.A., York Business Center, Suite 205, 3209 W. 76th St., Edina, MN, 55402, US

(73) Assignee: JASC Software, Inc.

(21) Appl. No.: 09/897,736

(22) Filed: Jul. 2, 2001

(51) Int. Cl. G06K 9/48

(52) U.S. Cl. 382/199

(57) ABSTRACT

A method of processing digital image data comprises

overlaying a hexon pattern structure on the digital image data to define a central area comprising a pixel or group of pixels, the hexon pattern comprising a group of pixels and/or a pattern of groups of pixels surrounding the central area, the overlaying of the geometric pattern defining a geometric region in relation to the central area,

assigning brightness values to the pixels within the groups of pixels and/or to individual groups of pixels,

comparing the brightness values of the groups of pixels using a local radial angular transform, and

detecting regions of contrast within the image data.

### BACKGROUND OF THE INVENTION

1. Field of the Invention

This invention relates to the field of imaging, the field of image data, the field of analyzing image data, the field of analyzing digital image data, and the detection of lines and line-type features in images through analysis of image data.

2. Background of the Art

In digital image processing, there is frequently a need to detect lines in an image. The range of applications in which such a need arises is very broad. Examples of the situations in which detection may be particularly important include vectorization of raster engineering drawings, detection of structures such as nerves or blood vessels in medical images, identification of roads in satellite images or maps, lane line detection for autonomous vehicles, crack detection, defect detection in images, detection of weather features, detection of boundaries, and handwriting recognition, to name but a few areas of practice where line detection can be particularly important.

In the most general sense, line detection involves recognition of curvilinear structures, not just straight lines. Lines according to the present invention are therefore defined as a collection of contiguous or continuously associated points with the association having one predominant dimension (e.g., length) in the collection of points that is much larger (e.g., greater than 5:1, greater than 10:1, greater than 15:1, greater than 25:1, greater than 50: 1, greater than 100:1, etc.) than another dimension (e.g., width), with the ratio being dependent, in part, upon the absolute size of the major dimension. For example, a line of 100 millimeters in length and 0.2 millimeters in width caused by a razor cut across an image surface is no less a line if the cut is only 2 millimeters in length and 0.2 millimeters in width) than the other dimension (width). The dimension of depth in the actual article is generally immaterial, as depth will not be a factor in two-dimensional image data that can be used to generate an image, although image features relating to depth, such as shadowing, roughness, etc. may be included within the image data. Such line structures are distinct from object boundaries, which are demarcations between large areas of different brightness, even though both boundaries and lines in an image exhibit an edge response. While a line of finite width has edges, it is characterized by being much longer than it is wide (as described above) and is thus distinct from the edges created at the boundaries of extended objects in an image. Detection of a line requires that both its location and width can be accurately described, since frequently, only lines within a certain range of widths are of interest.

Most of the approaches to line detection are based in some way on detection of edges. Methods of edge detection have been reviewed by D. Ziou and S. Tabbone, “Edge Detection Techniques”, Technical Report No. 195, Departement de Mathématiques et Informatique, Université de Sherbrooke, Canada, 1997. Schemes for line detection range from a concentration on local brightness differences in the image through detection of lines as objects having parallel edges to more sophisticated techniques. Some of these more sophisticated techniques use the curvature of the brightness of the image for estimation of lines using contours, ridges and ravines and locally fitting the curvature of the image. The field of line detection has been reviewed by C. Steger, “An Unbiased Detector of Curvilinear Structures”, Technical Report FGBV-96-03, Forschungsgruppe Bildverstehen, Informatik IX, Technische Universität Müinchen, Germany, 1996. Many methods are of considerable computational complexity and there remains a need for simple and rapid methods for detecting lines of different scales in the presence of other image features.

In M. I. Trifonov and P. A. Medinnikov, Sov. J. Opt. Technol., 58, 235-238 (1991) there is reported a local radial angular transform for images (‘loral’ transform). This transform is described for a hexagonal grid representation of a binary image, which does not conform to the conventional representation of an image as pixels on a rectangular grid. The same transform in a hierarchical hexagonal form was also briefly discussed in M. I. Trifonov and Yu. E. Shelepin, Perception, 21, Suppl. 2, 54 (1992). In this publication, the role of the transform as a possible model for the early stages of human vision was considered with relation to the ability for visual detection of shapes. However, no practical application of the local radial-angular transform in image processing has been reported.

### SUMMARY OF THE INVENTION

One aspect of this invention comprises methods of image processing based on a local radial angular transform. Another aspect of the invention is to provide a method of detecting lines and line-like features in images using the local radial angular transform. Another aspect of the invention is to provide a means of detection of lines in images in the presence of edges caused by the boundaries of other objects, distinguishing between the two features. A still further aspect of the invention is to provide a means of detecting lines of predetermined width in an image by means of the local radial angular transform. Yet another aspect of the invention is to provide a means of hierarchical description of the lines in an image according to scale by means of a local radial angular transform. An additional aspect of the invention is to provide a means of detecting other image features or shapes, including semi-planes, triangles, line junctions, rings or disks.

### BRIEF DESCRIPTION OF THE FIGURES

FIG. 1 shows a hexon with quasipixels formed as squares of size 2 by 2 in number of actual image pixels.

FIG. 2 shows two orientations of a hexon based on 2 pixel by 2 pixel quasipixels that are not contiguous. This illustrates two orientations based on the same quasipixel with a larger spacing.

FIG. 3 illustrates two orientations in a hexon based on the same quasipixel of FIG. 2 with a larger spacing.

FIG. 4 illustrates two orientations in a hexon based on the same quasipixel of FIG. 2 with still larger spacing.

FIG. 5 illustrates two orientations in a hexon based on the same quasipixel of FIG. 2 with still larger spacing.

FIG. 6 illustrates an orientation of a quasipixel that does not fall exactly on pixels boundaries, illustrating a situation where pixels have partial membership of a given quasipixel

FIG. 7 shows hexons in a first additional arrangement based on quasipixels having a size of one pixel.

FIG. 8 shows hexons in a second additional arrangement based on quasipixels having a size of one pixel.

FIG. 9 shows hexons formed from contiguous quasipixels that are 3 pixels by 3 pixels in size.

FIG. 10 shows hexons formed from non-contiguous quasipixels that are 3 pixels by 3 pixels in size.

FIG. 11 shows hexons formed from non-contiguous quasipixels that are 3 pixels by 3 pixels in size.

FIG. 12 shows a first arrangement of quasipixels based on 4 by 4 pixel quasipixels.

FIG. 13 shows a second arrangement of quasipixels based on 4 by 4 pixel quasipixels.

FIG. 14 shows a third arrangement of quasipixels based on 4 by 4 pixel quasipixel.

FIG. 15 shows quasipixels with contiguity composed of five image pixels or by virtue of corner-to-corner contact.

FIG. 16 shows quasipixels with contiguity comprising four image pixels.

FIG. 17 shows quasipixels where hexons are organized hierarchically.

FIG. 18 shows the detection of straight lines of various widths and orientations (at the top of the Figure), an image of |c₃| responses of the local radial angular transform obtained as max(|c₁₃|, |c₂₃|) using the hexon of FIG. 1 (in the center of the FIG. 18) under the constraint max(δ₁₃, δ₂₃|) 0.49.

FIG. 19 shows a comparison of detected original line-containing figures, and line detections by LORA analysis and Sobel analysis.

FIG. 20 shows a comparison of original line-containing figures, and line detections by LORA analysis and Sobel analysis.

FIG. 21 shows a comparison of original line-containing figures, and line detections by LORA analysis and Sobel analysis.

FIG. 22 shows the use lines of width 2, 6 and 12 pixels and that a particular line width can be detected in the presence of lines of other widths.

FIG. 23 shows a line that increases progressively from a width of one pixel to a width of 20 pixels.

FIG. 24 shows a line—4 pixels at its narrowest—whose edges become progressively more blurred and indistinct along its length.

FIG. 25 shows dashed lines that are magnified two-fold to show detail. The upper portion shows a line of width 6 pixels, with a dash length of 30 pixels and a gap length of 20 pixels.

FIG. 26 shows a collection of filled shapes, empty shapes and lines. The lines are 2 pixels wide. At bottom is shown the response of the Sobel edge filter to this image. All the objects are detected, with lines appearing as double edges. The center shows the LORA |c₂| response of the hexon of FIG. 12.

FIG. 27 shows a variety of black shapes on a 50% gray background. This image was processed with the hexon of Example 5 having 6 pixel by 6 pixel quasipixels and with max(δ₁₄, δ₂₄) 0.81.

FIG. 28 shapes on a 50% gray background, magnified six-fold for clarity. The image was processed with the hexon of Example 5 having 10 pixel by 10 pixel quasipixels with restriction of responses.

### DETAILED DESCRIPTION OF THE INVENTION

A digital image comprises a collection of picture elements or pixels arranged on a regular (e.g., Cartesian-type, or other point-by-point identifiable grid, pixel-by-pixel identifiable grid, with point or pixel identification indicating a specific space within a field) grid. A gray scale image is typically represented by a channel of specific brightness values at individual pixel locations. Such a channel may also be represented as a color palette, for example, a palette containing 256 shades of gray. A color image contains several channels, usually three or four channels, to describe the color at a pixel. For example, there may be red, green and blue (RGB) channels, or cyan, magenta, yellow channels (CYM) and black as the fourth (CMYK) channel. Each channel again contains brightness values representing the color at each pixel. Additionally, the image may be represented in a color space having a lightness channel along with other channels directly or indirectly representing the hue and saturation components of color. Examples include the HLS, HSV, YIQ, YUV, YES, CIE L*u*v* and CIE L*a*b* color spaces. All the aforementioned channels and any other image data formats for describing color space that include a brightness component are particularly suitable for the practice of the invention, although other color image data formats may be used with less facility.

The method of this invention may use a local radial angular transform (referred to herein as a ‘lora’ or ‘LORA’ transform) utilizing a hexagonal structuring of pixels or groups of pixels, termed a hexon, overlaid over the pixels of the image. Any hexagonal structuring of pixels or groups of pixels with reference to a central pixel, especially those that approach geometric symmetry or are close to the level of geometric symmetry allowed by the use of pixels (in one of or both a horizontal direction and a vertical direction) may be used as the hexagonal geometric structure. The description of the invention, for brevity, will focus on an illustrated group of pixels as representative of hexons (a distribution of six pixels or six groups of pixels surrounding a central pixel or central group of pixels). Because the hexons are usually selected with whole integer Cartesian coordinates as their centers, there are few, if any, geometric structures that will be provided as regular polygons, even though they may have two different symmetries (vertical and horizontal, although the symmetries are not identical as they would be with regular polygons). The fact that the hexons are not necessarily regular is of no consequence to the practice of the invention. Procedures for performing this overlay will be described later, after the properties of the hexon have been described. The hexon consists of a central reference pixel or group of pixels surrounded by six pixels or six groups of pixels arranged in approximate two or three-way symmetry about the central group. The distribution of the groups of pixels about the central pixel may not or need not be truly symmetrical as is the case with a regular hexagon, as long as the distribution of the surrounding pixels remains approximately uniform when comparing different central pixels.

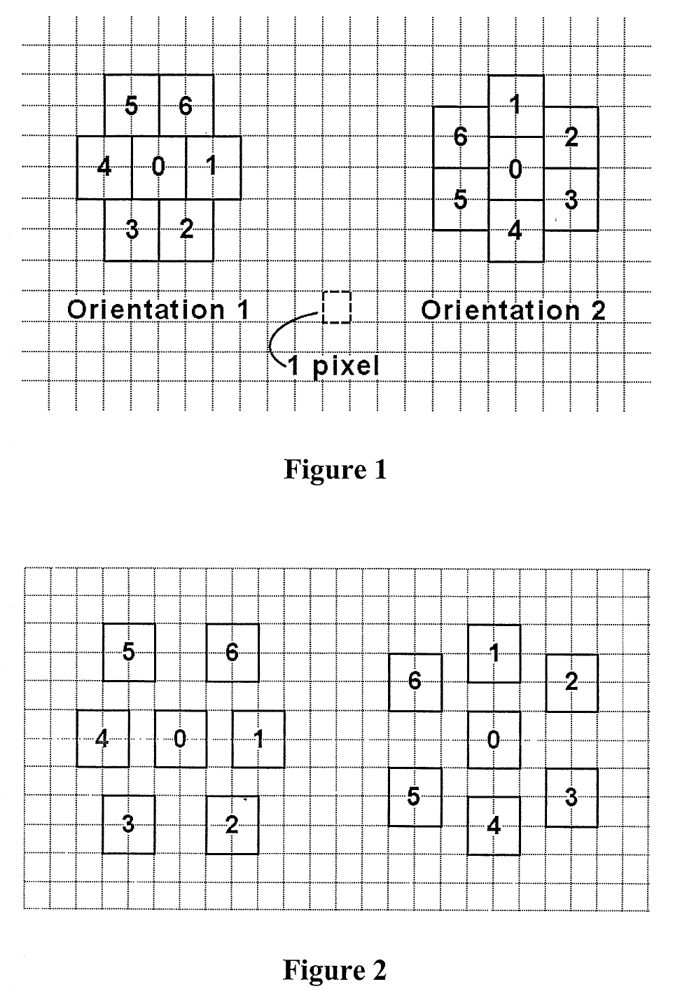

FIG. 1 shows two non-limiting orientations of such a symmetrical, but non-regular hexagonal arrangement of pixel groups. The numbers shown in the figure identify each of the pixel groups and appear as subscript labels in the following description.

For any channel of the image, the average brightness values or channel values can be computed within any one of the peripheral groups of pixels surrounding the central reference group. It is preferred that the groups are chosen in such a way that, if the image is everywhere of exactly the same arbitrary non-zero brightness, the sum of the brightness values of all the pixels in every group is a constant. That is to say, it is preferred that, while the groups may be of any shape, size or orientation, even different from each other, if each such group were to be placed in turn over the same region of an image the sum of brightness values in each group would be approximately the same. This sum may be computed as a simple sum or a weighted sum. In an image having any particular brightness values at its pixels, the mean brightness values of the six groups surrounding the central group may be represented as a vector B=(B₁, B₂, B₃, B₄, B₅, B₆)^{T}, where the superscript T denotes a transpose operation that converts a row matrix to a column matrix. A Local Radial Angular (LORA) transform L c is defined as c=RB, where c=(c₁, c₂, c₃, c₄, c₅, c₆)^{T} is a vector of transformation coefficients. R in the case of the hexon is a six by six square matrix whose elements are formed according to:

Rₖₘ=(1/6) exp[i(k−1)(m−1)π/3], ∥(k, m=1, 2 . . . 6)

where i is the imaginary unity (i.e., the square root of −1), πis the ratio of the circumference to the diameter of a circle, and k and m are the row and column indices of the matrix elements. For another geometric figure, the numbers would be adjusted to reflect the different number of groups (e.g., 8, 10 12, etc., in the geometric pattern). The matrix R may be represented for convenience in terms of a real matrix P and an imaginary matrix Q according to:

R=[1/(26)]P+i[1/(22)]Q

The elements of the matrix P are formed according to:

Pₖₘ=2 cos[(k−1)(m−1)π/3], ∥(k, m=1 2 . . . 6)

and those of Q according to:

Qₖₘ=(2/3) sin[(k−1)(m−1)π/3], ∥(k, m=1, 2 . . . 6)

P and Q are integer matrices with the explicit form shown below.

$$P = \vert \begin{matrix}2 & 2 & 2 & 2 & 2 & 2 \\ 2 & 1 & - 1 & - 2 & - 1 & 1 \\ 2 & - 1 & - 1 & 2 & - 1 & - 1 \\ 2 & - 2 & 2 & - 2 & 2 & - 2 \\ 2 & - 1 & - 1 & 2 & - 1 & - 1 \\ 2 & 1 & - 1 & - 2 & - 1 & 1\end{matrix} \vert Q = \vert \begin{matrix}0 & 0 & 0 & 0 & 0 & 0 \\ 0 & 1 & 1 & 0 & - 1 & - 1 \\ 0 & 1 & - 1 & 0 & 1 & - 1 \\ 0 & 0 & 0 & 0 & 0 & 0 \\ 0 & - 1 & 1 & 0 & - 1 & 1 \\ 0 & - 1 & - 1 & 0 & 1 & 1\end{matrix} \vert$$

Any one of the six transformation coefficients (k=1, 2 . . . 6) can be computed according to:

cₖ=Rₖ₁B₁+Rₖ₂B₂+Rₖ₃B₃+Rₖ₄B₄+Rₖ₅B₅+Rₖ₆B₆

Through the use of matrices P and Q, the real and imaginary parts of any of the six transformation coefficients (k=1, 2 . . . 6) can be computed independently, thus:

Real(cₖ)=(0.5/6)(Pₖ₁B₁+Pₖ₂B₂+Pₖ₃B₃+Pₖ₄B₄+Pₖ₅B₅+Pₖ₆B₆)

Imaginary(cₖ)=(0.5/2)(Qₖ₁B₁+Qₖ₂B₂+Qₖ₃B₃+Qₖ₄B₄+Qₖ₅B₅+Qₖ₆B₆)

The resulting expressions for each of the transformation coefficients are given below.

c₁=(1/6)(B₁+B₂+B₃+B₄+B₅+B₆)

c₂=(0.5/6)(2B₁+B₂−B₃−2B₄+B₅+B₆)+i(0.5/2)(B₂+B₃−B₅−B₆)

c₃=(0.5/6)(2B₁−B₂−B₃+2B₄−B₅−B₆)+i(0.5/2)(B₂−B₃+B₅−B₆)

c₄=(1/6)(B₁−B₂+B₃−B₄+B₅−B₆)

c₅=(0.5/6)(2B₁−B₂−B₃+2B₄−B₅−B₆)−i(0.5/2)(B₂−B₃+B₅−B₆)

c₆=(0.5/6)(2B₁+B₂−B₃−2B₄−B₅+B₆)−i(0.5/2)(B₂+B₃−B₅−B₆)

It can be seen that c6 is the complex conjugate of c2, and c5 is the complex conjugate of c3. Since the modulus |z| of a complex number z=a+ib is given by |z|=(a²+b²), then |c₂|=|c₆| and |c₃|=|C₅|. Further, it can be noted that coefficient cl is simply indicative of the mean channel value or brightness under the hexon. There are separate coefficients c₁ₖ and c₂ₖ for the orientations 1 and 2 of a hexon, such as shown in FIG. 1.

The modulus |c₃| of the transformation coefficient c₃ has been found to be a significant quantity. The magnitude of this modulus is an indicator of the presence of a line-like feature in the image lying under the hexon superimposed over the image. Referring to FIG. 1, for orientation 1 of the hexon, the orientation θ₁ of the line-like feature measured anticlockwise from the image horizontal is:

θ₁=arctan[Imaginary(c₃)/Real(c₃)]

while for orientation 2 or the hexon, the orientation θ₂ of the line-like feature is:

θ₂=arctan[Imaginary(c₃)/Real(c₃)]+π/2

The angle θ is a continuous function of c₃, giving rise to angles in the interval 0 to 180 degrees, but for exact hexagonal symmetry, the highest accuracy in θ is obtained near (but not necessarily exactly at) angles of 0, 30, 60, 90, 120 and 150 degrees. In practice, the θ angles of highest accuracy deviate slightly from these values because the requirement to map the hexon to pixels on a square grid leads to slight distortions of the hexagonal symmetry. For example, in the arrangement shown in FIG. 1, the angles of highest accuracy in θ are 0, 26.6, 63.4, 90, 116.6 and 153.4 degrees. The estimate of the orientation angle of the line-like feature can also, for instance, be improved by computing the angle as an average of θ₁ and θ₂ weighted by the |c₃| responses of the two orientations of the hexon.

As noted earlier, the hexon may be composed of groups of pixels, termed quasipixels for convenience or nomenclature. The hexon allowed is quite broad in scope, even though certain specific pixel and pixel group distributions are preferred. By way of non-limiting examples, the following arrangement of pixels, in addition to those shown in the Figures and elsewhere described in the specification, are provided:

Quasipixel 1=1 pixel

Quasipixel 2=a group of 49 pixels in a 7×7 pixel square whose output is scaled by dividing by 49.

Quasipixel 3=49 pixels arranged in a vertical row whose output is scaled by dividing by 49.

Quasipixel 4=5 pixels arranged in an L-shape whose output is scaled by dividing by 5.

Quasipixel 5=a hollow triangle of 12 pixels whose output is scaled by dividing by 12.

Quasipixel 6=5 pixels arranged in a cross with the center pixel receiving twice the weight of other pixels and whose output is scaled by dividing by 6.

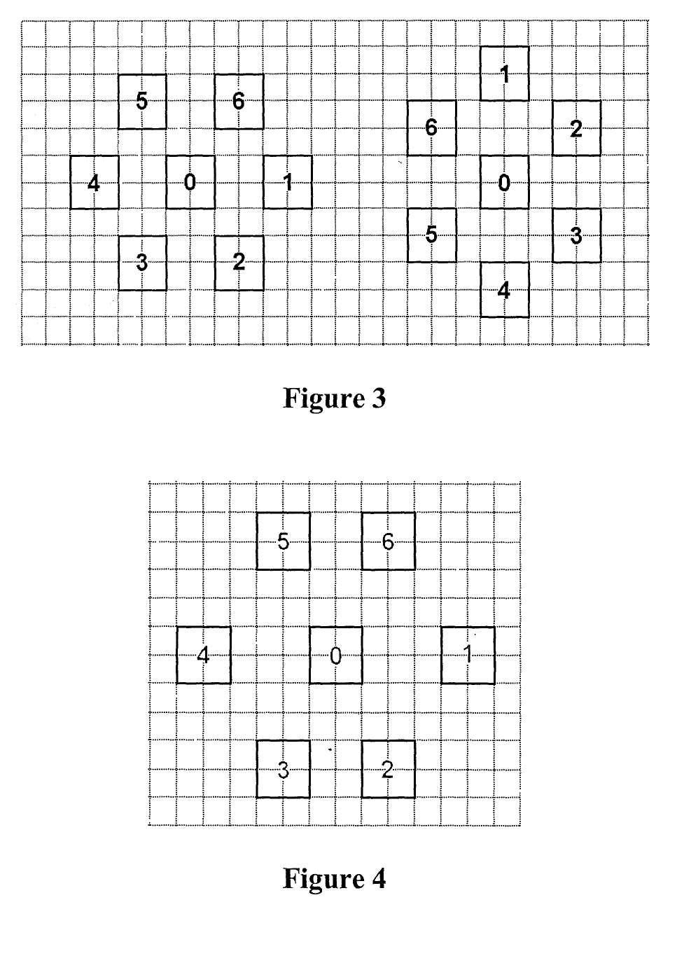

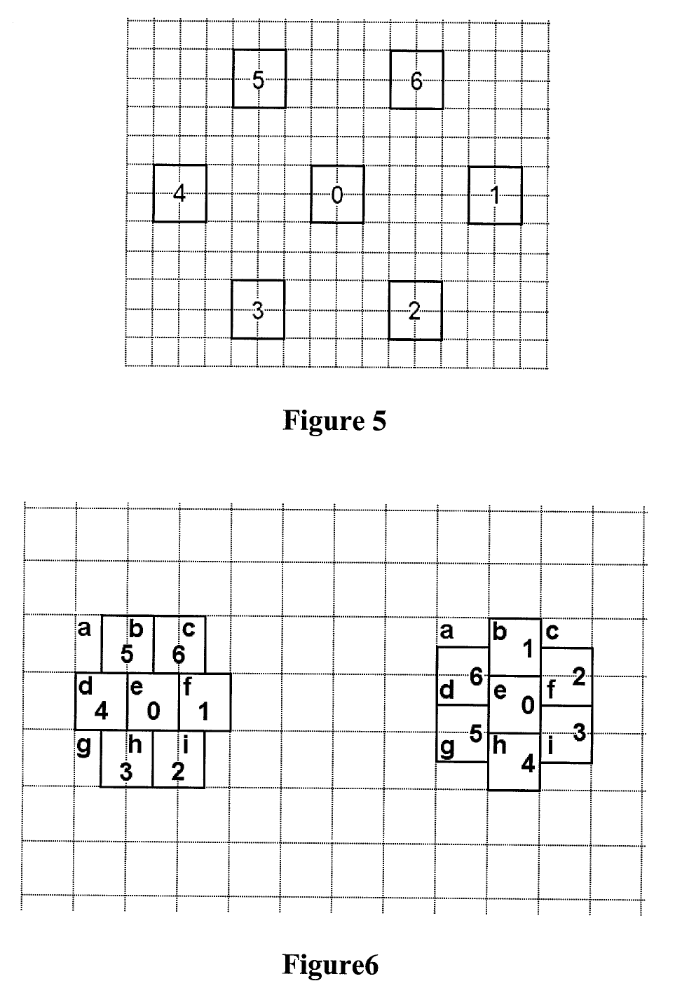

Pixel groups are distributed about the central pixel or central group of pixels, preferably with some form of symmetry, but as noted elsewhere, the hexon can be weighted or eccentrically located about the central pixel. In FIG. 1, the quasipixels are formed as squares of size 2 by 2 in number of actual image pixels. In this example, the quasipixels are shown in this FIG. 1 as contiguous. The invention, however, envisages a very broad range of arrangements of quasipixels, distributions of pixels within the quasipixels, numbers of pixels within the quasipixels, and the like. The size, shape, pixel membership and spacing of the quasipixel groups can vary widely, provided that approximate hexagonal distributions, (including, for example, symmetry) are maintained. As the quasipixel size is varied, line features of different width or scale may be detected selectively. When the quasipixels are spaced apart, it becomes possible to detect dashed lines. Some illustrative, but not restrictive examples are shown in the figures. FIG. 2 demonstrates two orientations of a hexon based on 2 pixel by 2 pixel quasipixels that are not contiguous. FIG. 3 illustrates two orientations based on the same quasipixel with a larger spacing. FIGS. 4 and 5 show larger spacings still. In FIG. 6 the quasipixel does not fall exactly on pixels boundaries, illustrating an acceptable situation according to the invention where pixels have partial membership of a given quasipixel. In the figure, individual image pixels are designated by lower case letters and the quasipixels are designated by numbers. Thus, for example, quasipixel 5 has the pixels a and b as partial members. The mean brightness at quasipixel 5, B₅, can be calculated,as a weighted sum of the contributions Bₐ and B_{b} of the pixels a and b so:

B₅=0.5 Bₐ+0.5 B_{b}

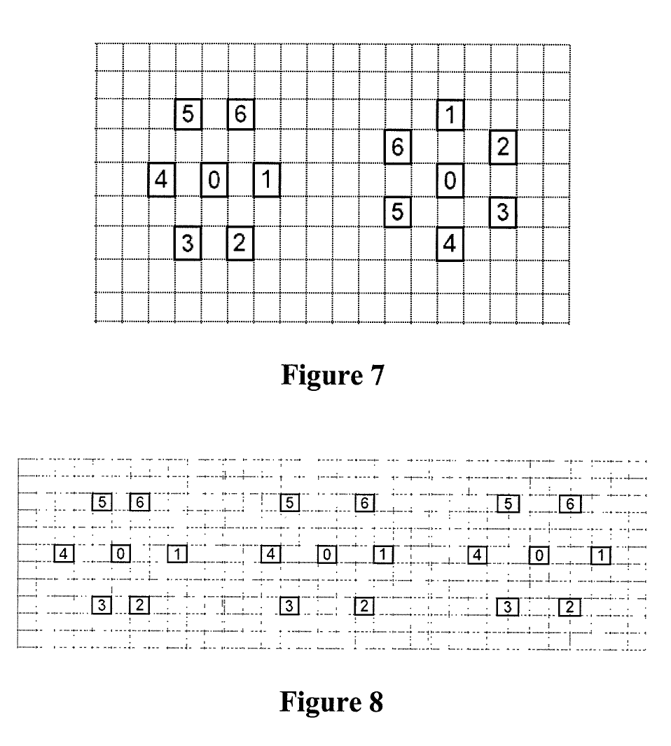

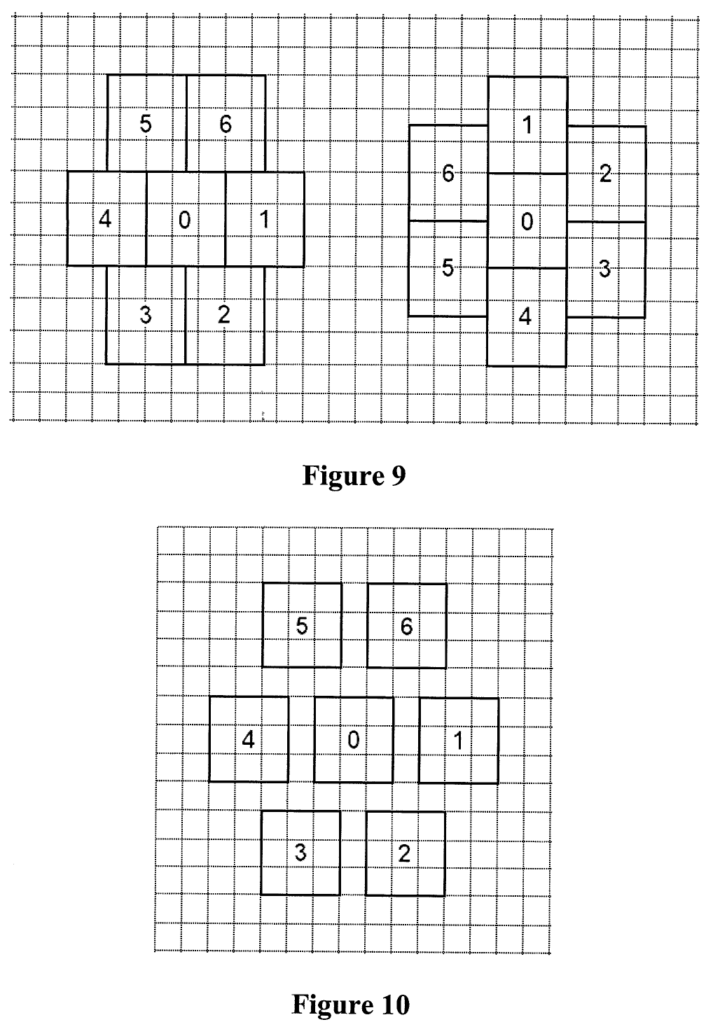

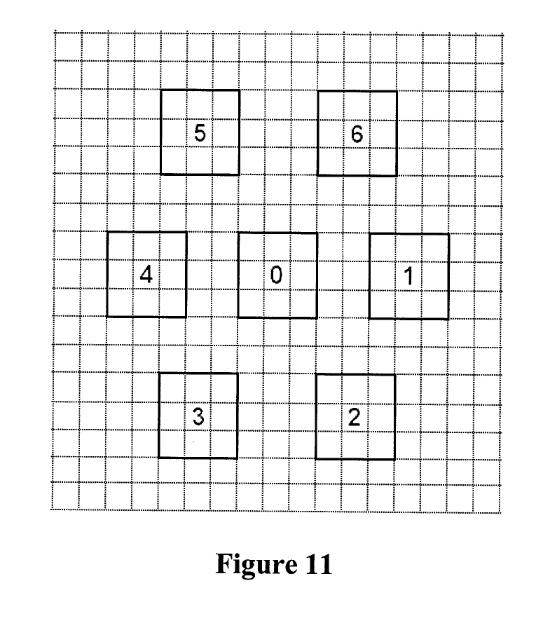

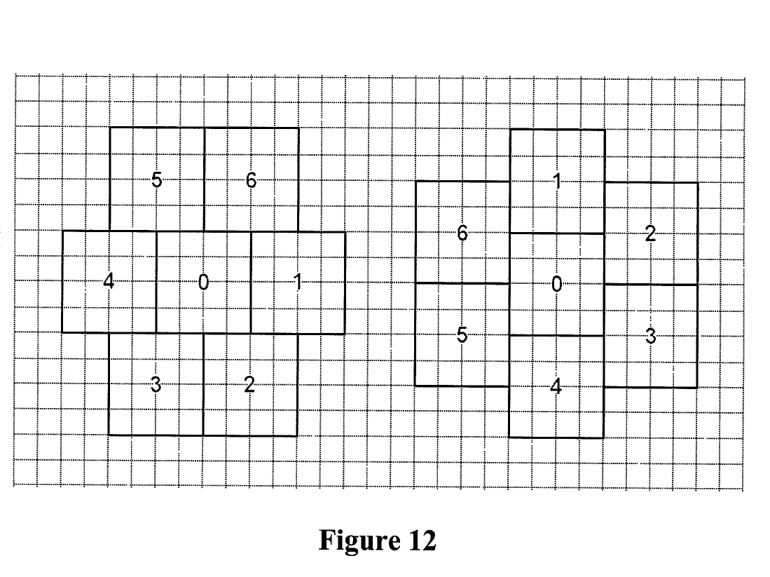

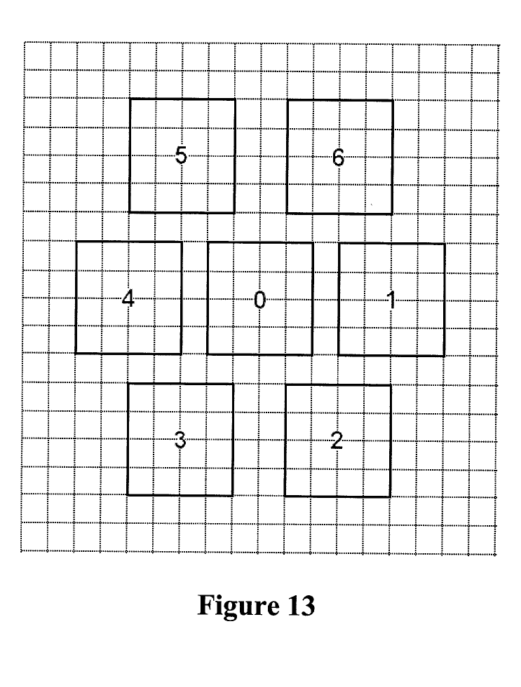

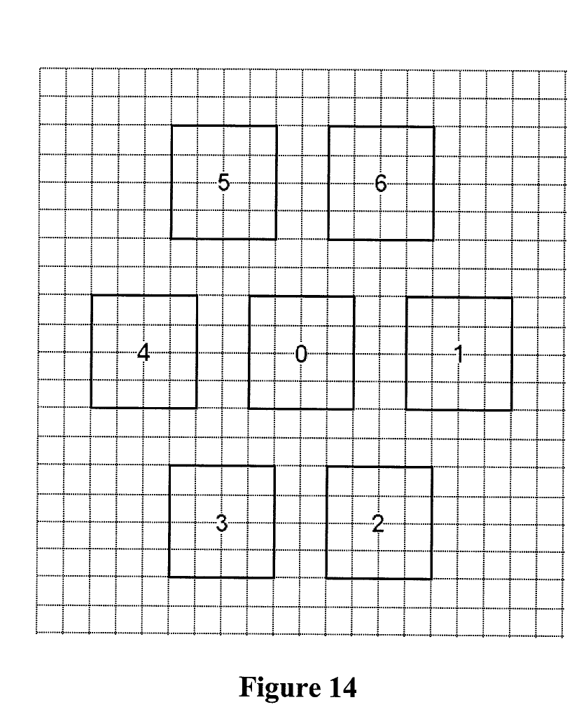

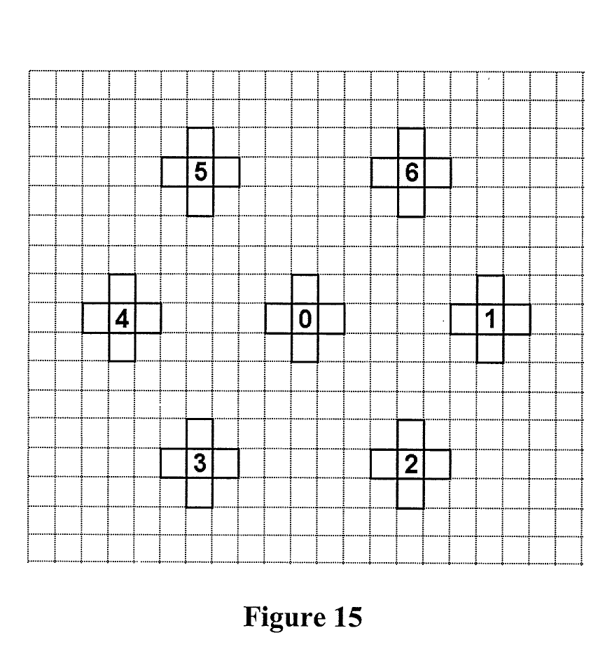

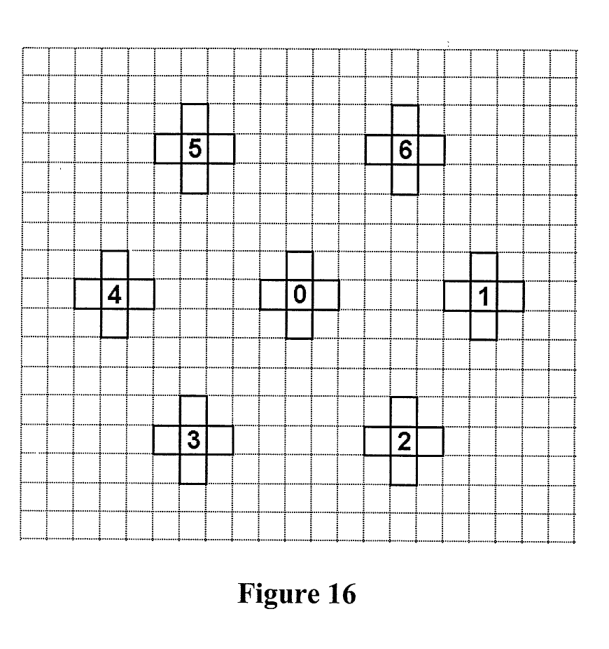

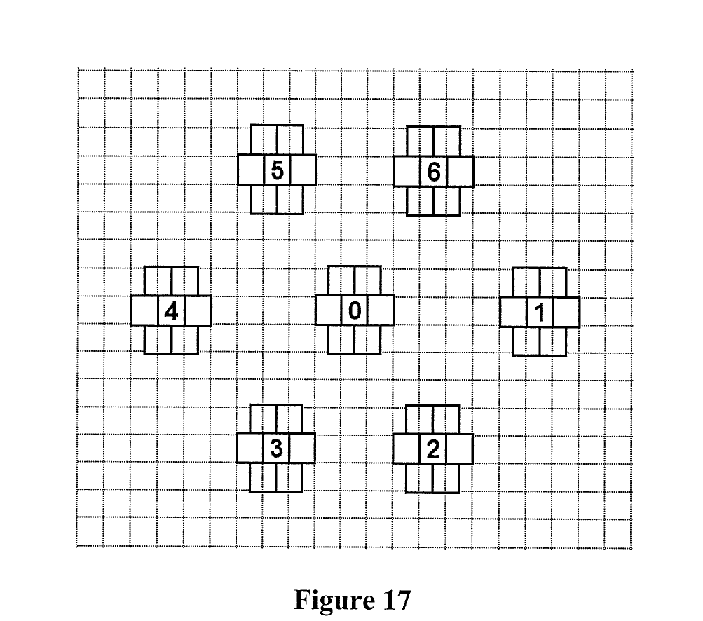

This permits the hexon to achieve pixel-level resolution. The values of B₂, B₃ and B₆ are computed analogously, while B₁ and B₄ are obtained directly from the brightness of the underlying pixels f and d respectively. FIGS. 7 and 8 indicate additional arrangements based on quasipixels having a size of one pixel. For the rightmost variant in FIG. 8, quasipixels 2, 3, 5 and 6 again have partial pixel membership. Hexons formed from quasipixels that are 3 pixels by 3 pixels in size are illustrated in FIGS. 9, 10 and 11. The quasipixels are contiguous in FIG. 9 and discontiguous in FIGS. 10 and 11. Similar arrangements based on 4 by 4 pixel quasipixels are shown in FIGS. 12 to 14. The choice of hexons composed of quasipixels of a different size allows line features of different widths to be detected selectively. In all the examples, the pixels forming the quasipixels are part of the same group because of contact or contiguity of the individual pixels. This contiguity may be by virtue of side-to-side pixel contact as shown in FIG. 15 for quasipixels composed of five image pixels or by virtue of corner-to-corner contact, which is shown in FIG. 16 for quasipixels comprising four image pixels. Hexons may also be organized hierarchically as demonstrated in FIG. 17. The large scale hexon comprises quasipixels that are themselves hexons constructed from smaller quasipixels corresponding to a size of one image pixel. Such an arrangement may be used for simultaneously characterizing texture in an image at several scales. Additionally, it is possible to successively process an image with a range of hexon sizes based on quasipixels of increasing size in order to achieve a multiscale description of image content quantized to a chosen scale interval. This description may be organized in hierarchical form. By virtue of the integer form of matrices P and Q processing is rendered very rapid compared to conventional methods of multiscale description such as those using Gabor filters.

The central reference pixel or group of pixels does not participate directly in the LORA transform. However, it represents the location of the image at which the results of the LORA transform may be considered to apply. In one view, the central pixel or group of pixels is a conceptual location relative to which the symmetry of the hexon may be defined. In another view, the central pixel or group of pixels is a location with which the various outputs of the LORA transform may be associated. For example, if it is desired to record one of the possible useful outputs of the LORA transform (e.g., a coefficient cₖ, as described below) this may be done, for instance, by scanning the location of the central pixel group pixel-by-pixel across an input image and at each point assigning an output of the LORA transform to the equivalent location of an output image. Other than using the reference central group as a conceptual center of the hexon (e.g., for defining symmetry or assigning an output value), it is not required to use the central reference group. Despite this, it is contemplated that pixel values in the central reference group may also be used in conjunction with pixel values of the six peripheral groups that are used to compute the LORA transform to provide additional useful information that may not be available from the LORA transform alone. If the reference central group is used in this way, it may also be considered as a quasipixel and it is preferred that the central group have the properties specified earlier for quasipixels.

For any hexon type, such as those exemplified in FIGS. 1 to 17, a coefficient cₖ is calculated for every position of the hexon in relation to the image pixels. That is to say, the hexon center position is moved pixel by pixel across the rows and down the columns of the image until it has been positioned over every image pixel of interest. The result is an image formed from cₖ responses that is identical in size to the original image area of interest. It is also possible to move the hexon in larger steps. For instance, hexons composed of quasipixels comprising several pixels may be moved in steps equal to the quasipixel width or height. In such a case the output image will be smaller than the input image, being effectively a lower resolution or coarser scale image. The value of cₖ calculated for the hexon is a property of the central pixel of the hexon. In other words, it is a property of the central pixel of the quasipixel labeled 0 in FIGS. 1 to 17. When the width and height of the quasipixel is an odd number of pixels there is no ambiguity about the location of the center pixel. However, when the quasipixel has even dimensions, the center of the quasipixel does not coincide with an image pixel. In such a case it is usually sufficient to assign cₖ to that image pixel lying closest to the center of the quasipixel. When several pixel lie at equal distances from the center of the quasipixel an arbitrary choice can be made. For example, referring to FIG. 1, cₖ may be assigned to the top left pixel of quasipixel 0. It is also possible in such a case to form an improved value of cₖ at a given pixel by averaging the responses from several positions of the central quasipixel each lying over the pixel in question. For instance, referring to FIG. 1, the response at a given pixel may also be formed as the average of cₖ values obtained by positioning in turn the top left, top right, bottom left and bottom right elements of quasipixel 0 over the given image pixel. Alternatively, all pixels lying under central quasipixel may be assigned the value of cₖ determined for one pixel in this region. There is a separate value of |cₖ| for orientation 1 and orientation 2 of the hexon. These separate values |c₁ₖ| and |c₂ₖ| may be combined into a single value |cₖ|, for instance by taking the larger of the two.

As noted before, the magnitude of |c₃| is a measure of the presence of a line-like feature under the hexon. An image formed from |c₃| responses is, therefore, an image of the line-like elements of the original image. |c₃| may be scaled linearly or non-linearly to any convenient representation as a channel value of an image. It may be thresholded by whatever selection best meets the needs of the application. For instance, values of |cₖ| may be retained only if they exceed a threshold or only if they lie within a range defined by a lower and upper threshold. The magnitude of |c₃| can be considered the strength of a line response in the image. It is also possible to define a different hexon response, δ₃, which is a measure of the line purity. This quantity is defined as:

$${δ}_{3} = 2 {\vert {c}_{3} \vert}^{2} {{/ {\vert {c}_{k} \vert}^{2}}^{k = 6}}_{k = 2}$$

Other definitions involving weighted functions of the coefficients cₖ are also possible. Since coefficients other than c₃ respond to image features that are not lines, δ₃ is a measure of the degree to which the c₃ response represents a line. There are separate values, δ₁₃ and δ₂₃, of this measure for hexon orientation 1 and orientation 2 respectively. These may be combined into a single value of δ₃ by any convenient means, for instance by using the larger value. Thus there are two means of line analysis—|c₃|, the line strength metric, and 63, the line purity metric. The strength metric responds, for instance, to the contrast of the line relative to its surroundings. High contrast leads to a high value of |c₃| and low contrast to a low value. The purity metric responds, for instance, to how well defined the line is. Lines with sharp edges yield high values of δ₃, while lines with blurred, ill-defined edges give smaller values of δ₃. The two metrics may be used independently or in combination. It is preferred to use both metrics in combination since this allows the maximum selectivity for a particular type of line. For instance, δ₃ may be tested against a threshold (even an arbitrary threshold) so that values of |c₃| are discarded or set to zero if δ₃ lies below the threshold. It is also effective to use a lower and upper δ₃ threshold so that |c₃| responses are retained only when the value of δ₃ lies within a certain range.

The c₃ coefficient responds to lines that are both dark and light with respect to the background upon which they lie and by default both types of lines are detected. However, it is also possible to selectively detect only light lines or only dark lines. This may be achieved in various ways. For example, the mean brightness or channel value at the quasipixels lying closest to the line may be compared to the value of c₁/6. Alternatively, the lightness or darkness of a line may be estimated from the real and imaginary parts of the c₃ coefficient by comparison to thresholds T₁ and T₂ according to the following logic:

if |Imaginary(c₃)/Real(c₃)| T₁ and Real(c₃)>T₂ then Light

if |Imaginary(c₃)/Real(c₃)|>T₁ and Real(c₃)<T₂ then Light

if |Imaginary(c₃)/Real(c₃)| T₁ and Real(c₃)<₂ then Dark

if |Imaginary(c₃)/Real(c₃)|>T₁ and Real(c₃)>T₂ then Dark

While the value of T₁ depends on the detailed geometry of the hexon, a preferred value of the threshold T₁ is from greater than about 0 to less than about 0.57. An especially preferred value is about 0.07 to about 0.41, about 0.15 to 0.35, and with a most especially preferred value of about 0.3. The preferred value of T₂ is about 0. In this way either light or dark lines may be separately detected.

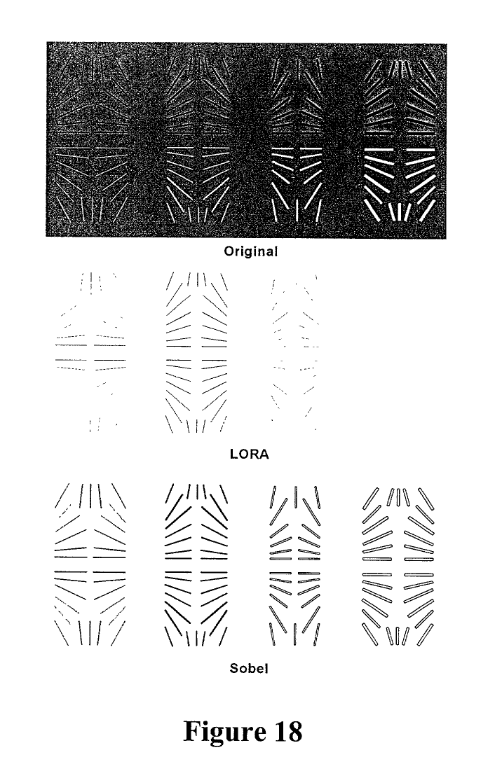

The invention will be further illustrated with the following, non-limiting examples. Example 1 (FIG. 18) shows at the top of the Figure a selection of straight lines of various widths and orientations. In the center is an image of |c₃ | responses of the local radial angular transform obtained as max(|c₁₃|, |c₂₃|) using the hexon of FIG. 1 under the constraint max(δ₁₃, δ₂₃) 0.49. At the bottom are the responses of the conventional Sobel edge detection filter. It can be seen that the LORA detector identifies the centers of both dark and light lines having width one, two and four pixels while ignoring lines with a width of seven pixels, which are wider than the four-pixel quasipixel of the hexon. In contrast the Sobel detector identifies the borders of the lines no matter what the size.

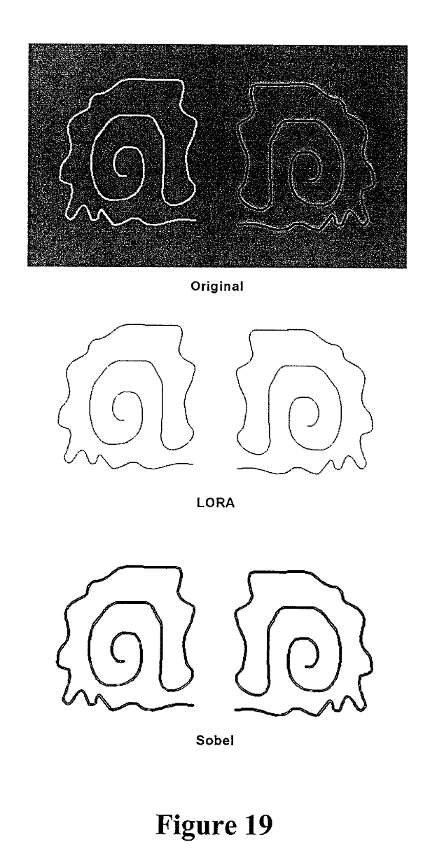

Example 2 (FIG. 19) was obtained using the detector of Example 1, and shows that the LORA detector is capable of tracing the center of a light or dark irregular curve. Once again the Sobel filter detects the line edges rather than its center. The image has been magnified two-fold to better show detail.

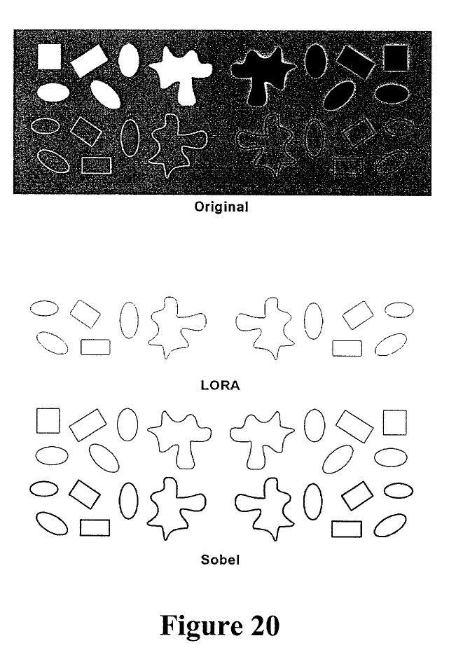

Example 3 (FIG. 20) contains several light and dark regular and irregular shapes show at the top. Some consist only of an outline while others are filled shapes. With the LORA detector of Example 1, only the outlines are detected. However, the conventional Sobel filter cannot distinguish between lines and the boundaries of filled objects.

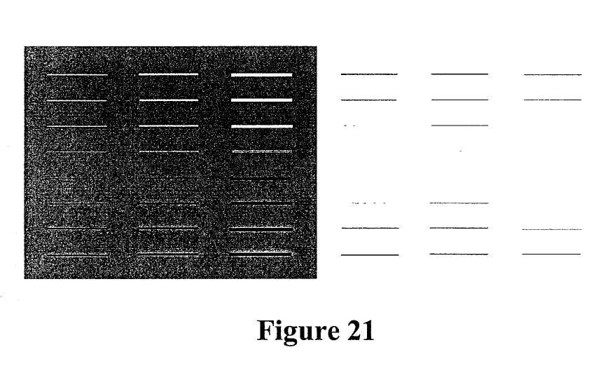

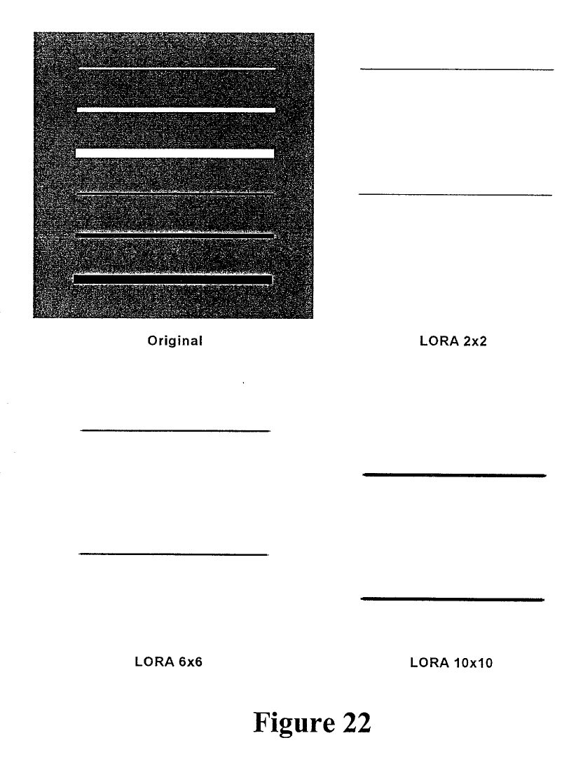

Example 4 (FIG. 21) shows on the left lines of differing width (1, 2 and 4 pixels) with different brightness relative to the gray background (0%, 12%, 25%, 37%, 62%, 75% 87% and 100% gray). The image has been magnified two-fold to reveal detail. On the right is the response of the LORA detector of Example 1, illustrating detection of lines irrespective of contrast. The magnitude of the max|c₁₃|, |c₂₃|) response is, however, sensitive to the contrast. Example 5 (FIG. 22) shows using lines of width 2, 6 and 12 pixels that a particular line width can be detected in the presence of lines of other widths. The image has been magnified two-fold to show detail. All LORA detectors used a threshold max(δ₁₃, δ₂₃) 0.49. The 2-pixel lines were detected with the hexon of FIG. 1. The 6-pixel lines were detected with a 6 pixel by 6 pixel quasipixel arranged as in FIG. 1 and a threshold of max(|c₁₃|, |c₂₃|) 0.84 |c₃|_{max.}, where |c₃|ₘₐₓ is the largest c₃ response anywhere in the image for a particular hexon. The 12-pixel lines were detected with a 10 pixel by 10 pixel quasipixel arranged as in FIG. 1 and a threshold of max(|c₁₃|, |c₂₃|) 0.84 |c₃|ₘₐₓ. The detected lines may be organized hierarchically with respect to scale or width.

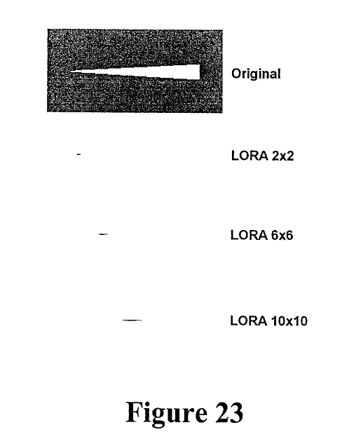

Example 6 (FIG. 23), which has been magnified two-fold, shows a line that increases progressively from a width of one pixel to a width of 20 pixels. Using the hexons of Example 5 with max(δ₁₃, δ₂₃) 0.49 and max(|c₁₃|, |c₂₃|) 0.9 |c₃ₘₐₓ, the ability to extract line sections of different distinct width is demonstrated.

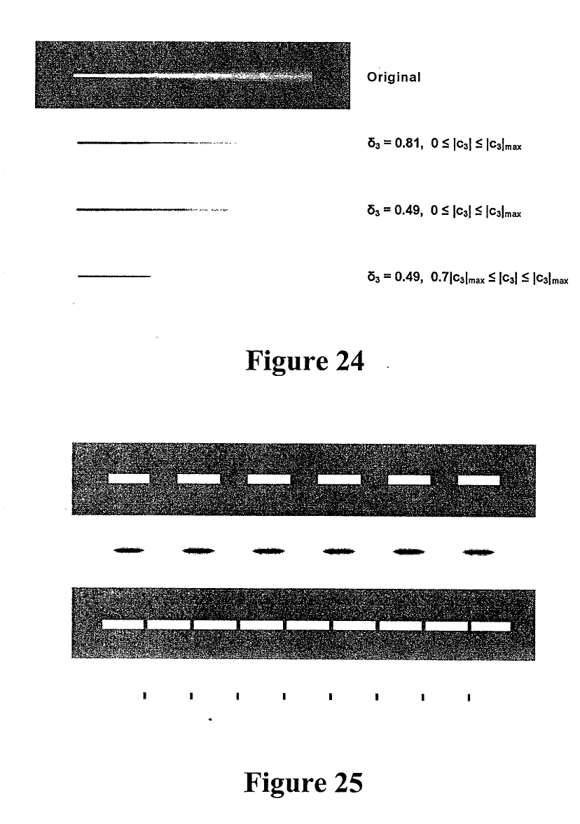

Example 7 (FIG. 24), again magnified two-fold, shows a line—4 pixels at its narrowest—whose edges become progressively more blurred and indistinct along its length. The relevant detector thresholds are noted in the figure. Using the hexon of 6 by 6 quasipixels from Example 5 regions of different line sharpness may be detected. A lower δ₃ threshold results in the line being detected as having uniform width, while a threshold on |c₃| permits only the sharp section of the line to be detected.

Example 8 (FIG. 25) concerns dashed lines and is magnified two-fold to show detail. The upper portion shows a line of width 6 pixels, with a dash length of 30 pixels and a gap length of pixels. The dash line elements are detected using the 6 by 6 quasipixel hexon of Example 5 with max(δ₁₃, δ₂₃) 0.49. The lower portion shows a line of width 6 pixels, with a 30 pixel long dash and a 3 pixel wide gap. The gap elements of the line are detected using the hexon of FIG. 1 with max(δ₁₃, δ₂₃) 0.49 and max(|c₁₃|, |c₂₃|) 0.7 |c₃|ₘₐₓ.

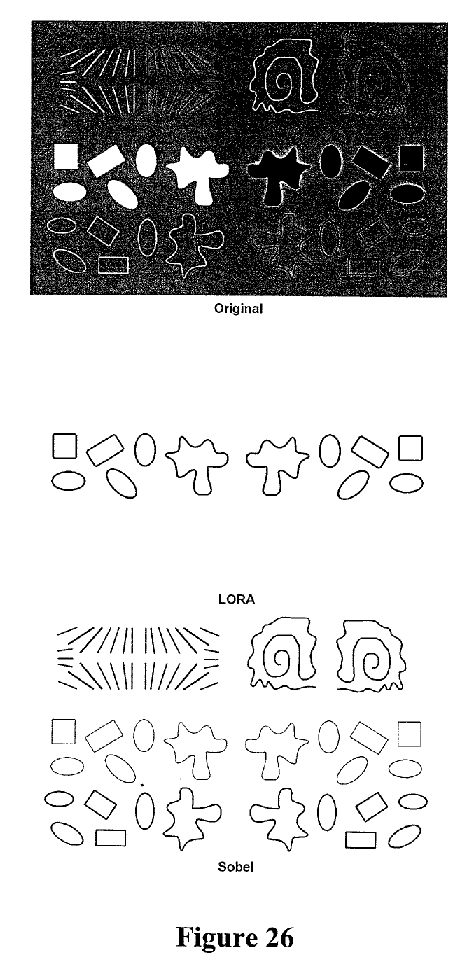

Example 9 (FIG. 26) shows at the top of the Figure a collection of filled shapes, empty shapes and lines. The lines are 2 pixels wide. At bottom is shown the response of the Sobel edge filter to this image. All the objects are detected, with lines appearing as double edges. The center shows the LORA |c₂ response of the hexon of FIG. 12 with max(δ₁₂, δ₂₂) 0.49 and max(|c₁₂, |c₂₂|) 0.7 |c₂ₘₐₓ illustrating that object boundaries may be selectively detected in the presence of other edges. In this case δ₂ is defined as:

$${δ}_{2} = 2 {\vert {c}_{2} \vert}^{2} {{/ {\vert {c}_{k} \vert}^{2}}^{k = 6}}_{k = 2}$$

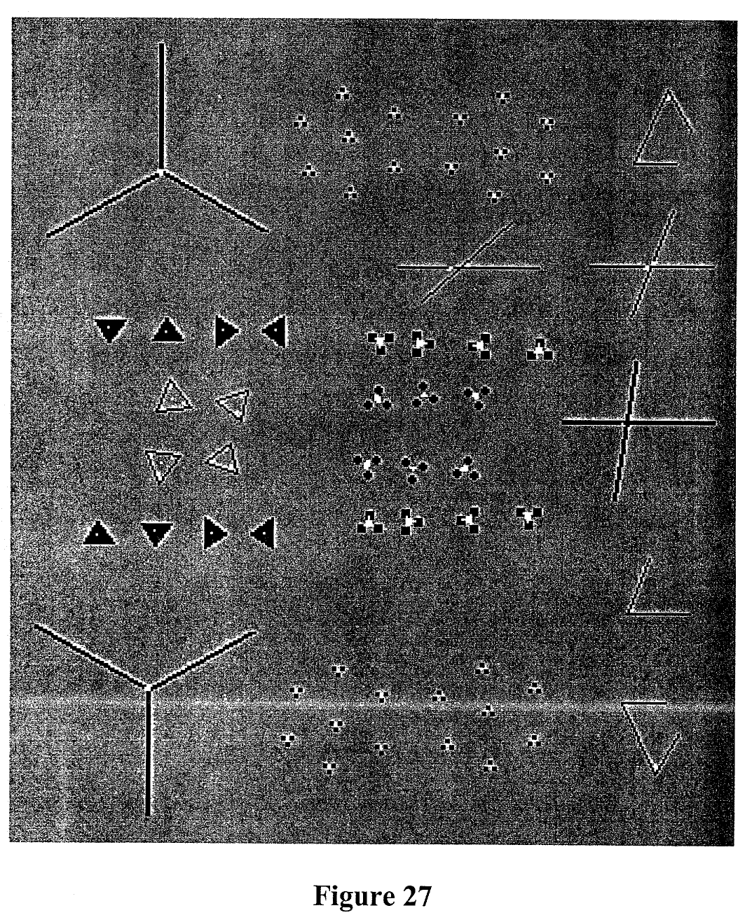

Example 10 (FIG. 27) shows a variety of black shapes on a 50% gray background. This image was processed with the hexon of Example 5 having 6 pixel by 6 pixel quasipixels and with max(δ₁₄, δ₂₄) 0.81, the results being magnified six-fold for clarity. Superimposed in white are the locations of the |c₄| responses of the hexon, which indicate a capability to detect triangular structures and certain types of line junctions and intersections. In this case δ₄ is defined as:

$${δ}_{4} = {\vert {c}_{4} \vert}^{2} {{/ {\vert {c}_{k} \vert}^{2}}^{k = 6}}_{k = 2}$$

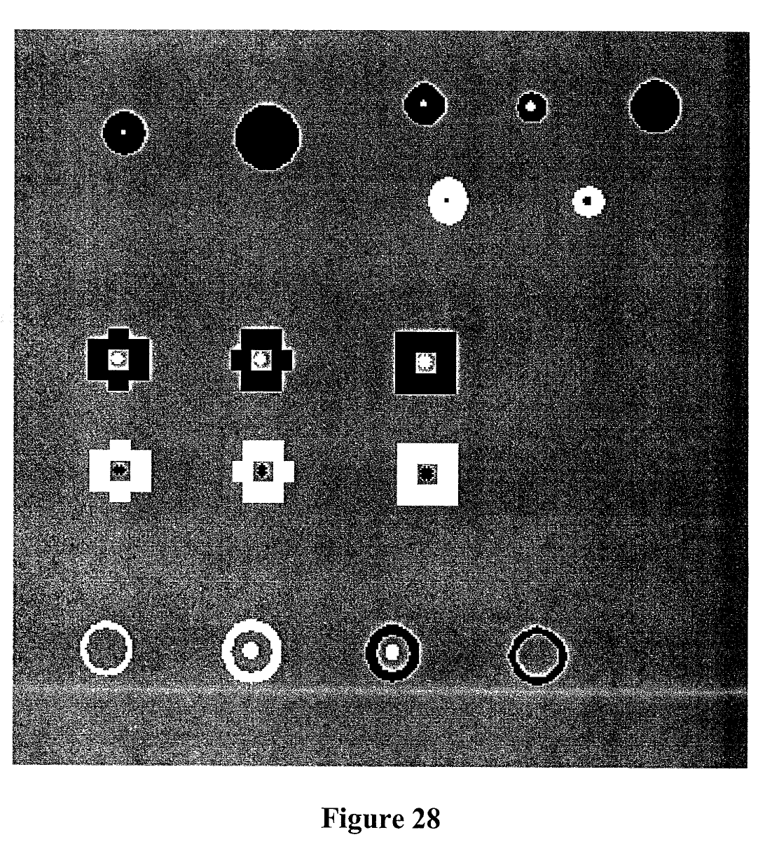

Example 11 (FIG. 28) presents some shapes on a 50% gray background, magnified six-fold for clarity. The image was processed with the hexon of Example 5 having 10 pixel by 10 pixel quasipixels with restriction of responses according to |c₂|<0.39cₖ|ₘₐₓ, |c₃|0.39|cₖ|ₘₐₓ, |c₄″<0.39|cₖ|ₘₐₓ and |B₀−c₁/6|>0.21Bₘₐₓ, where |cₖ|ₘₐₓ is the largest value of |cₖ| anywhere in the image and Bₘₐₓ is the maximum brightness of the image. In this example both of these values are 255. When all of |c₂|, |c₃|, |c₄|, |c₅| and |c₆| are small and |B₀−c₁/6| is large, then |B₀−c₁/6| responds to a disk-like or ring-like forms. The locations of this response are shown in FIG. 28 in white for black shapes and in black for white shapes centered in the shapes. The responses demonstrate that disks and rings can be detected. Two disks are too large to detect with the hexon used and two rings are too thin to detect with this hexon.

What is claimed

1. A method of processing digital image data comprising:
overlaying a hexon pattern structure on the digital image data to define a central area comprising a pixel or group of pixels, the geometric pattern comprising a group of six pixels and/or a pattern of six groups of pixels surrounding the central area, the overlaying of the geometric pattern defining a geometric region in relation to the central area,
assigning brightness values to the pixels within the groups of pixels and/or to individual groups of pixels,
comparing the brightness values of the groups of pixels using a local radial angular transform, and
detecting regions of contrast within the image data.

2. The method of claim 1 wherein the detected regions of contrast are used to determine if a line is present within the image.

3. The method of claim 1 wherein the detected regions of contrast are used to detect if a semi-plane is present within the image.

4. The method of claim 1 wherein the detected regions of contrast are used to determine if a triangular shape is present within the image.

5. The method of claim 1 wherein the detected regions of contrast are used to determine if a line junction is present within the image.

6. The method of claim 1 wherein the detected regions of contrast are used to determine if a disk shape is present within the image.

7. The method of claim 1 wherein the detected regions of contrast are used to determine if a ring shape is present within the image.

8. The method of claim 1 wherein a transform coefficient is used to identify areas within the hexon pattern structure to detect where a line might be present.

9. The method of claim 8 wherein a transform coefficient is used to identify areas within the hexon pattern structure to detect where a line might be present.

10. The method of claim 1 wherein a transform coefficient is used to identify areas within the hexon pattern structure to detect where a semi-plane might be present.

11. The method of claim 9 wherein a transform coefficient is used to identify areas within the hexon pattern structure to detect where a semi-plane might be present.

12. The method of claim 8 wherein the hexon pattern structure comprises the central group of pixels and an at least one-axis symmetrical arrangement of surrounding pixel groups.

13. The method of claim 8 wherein the symmetrical arrangement comprises six surrounding groups of pixels, each group of pixels having the same number of pixels as other groups, and the number of pixels in the groups being between 1 and 100.

14. The method of claim 13 wherein the comparing of a property is done by moving the central group of pixels uniform distances in relationship to the position of pixels in the image data.

16. The method of claim 14 wherein the comparing of a property is done by moving the central group of pixels uniform distances in relationship to the position of pixels in the image data and storing the comparisons.

17. The method of claim 15 wherein the comparing of a property is done with a transform coefficient.

18. The method of claim 15 wherein the comparing of a property is done with a transform coefficient.

19. The process of claim 16 wherein the uniform distance is approximately equal to a dimension of the central group of pixels.

20. The method of claim 8 wherein only lines within a range of predetermined width are detected.

21. The method of claim 8 wherein only lines of a predetermined darkness or brightness are detected.

22. The method of claim 8 wherein only lines of a predetermined orientation are detected.

23. The method of claim 8 wherein only lines of a predetermined edge sharpness are detected.

24. The process of claim 1 wherein the digital image data includes lines and edge features, and the detection of only lines of a predetermined width excludes the detection of at least some edge features.

25. The process of claim 1 wherein the digital image data includes lines and edge features, and the detection of only lines of a predetermined darkness or brightness excludes the detection of at least some edge features.

26. The process of claim 1 wherein the digital image data includes lines and edge features, and the detection of only lines of a predetermined orientation.

27. The process of claim 1 wherein the digital image data includes lines and edge features, and the detection of only lines of a predetermined edge sharpness.

28. A method of processing digital image data comprising detecting shapes of predetermined width in an image by means of application of a local radial angular transform to digital image data.

29. The method of claim 28 wherein the shapes are lines.

30. A method of processing digital image data comprising detecting shapes of predetermined brightness or darkness with respect to their surroundings in an image by means of application of a local radial angular transform.

31. The method of claim 30 wherein the shapes are lines.

32. A method of processing digital image data comprising providing a hierarchical description of shapes in an image according to scale by means of application of a local radial angular transform to digital image data.

33. The method of claim 32 wherein the shapes are lines.

34. A method of processing digital image data comprising utilizing responses selected from the group consisting of |c₃| line responses, |c₂| semi-plane responses, |c₄| triangle or line-junction/line-intersection, and |c₁/6−B₀| disk/ring responses for detecting objects.

35. A computer having hardware and software that enables execution of the process of claim 1.
